(19) United States
(12) Patent Application Publication
(10) Pub. No.: US 2025/0370425 A1
(43) Pub. Date: Dec. 4, 2025

(54) METHODS, INTERNET OF THINGS (IOT) SYSTEMS, AND MEDIUMS FOR SAFETY MONITORING OF PARTICULATE MATTER IN SMART GAS PIPELINE NETWORKS

(71) Applicant: CHENGDU QINCHUAN IOT TECHNOLOGY CO., LTD., Chengdu (CN)

(72) Inventors: Zehua SHAO, Chengdu (CN); Junyan ZHOU, Chengdu (CN); Xueqiang LEI, Chengdu (CN); Lei ZHANG, Chengdu (CN)

(73) Assignee: CHENGDU QINCHUAN IOT TECHNOLOGY CO., LTD., Chengdu (CN)

(21) Appl. No.: 19/302,094

(22) Filed: Aug. 18, 2025

(30) Foreign Application Priority Data
Jul. 21, 2025 (CN) 202510998397.6

(51) Int. Cl. G05B 19/406

(52) U.S. Cl. CPC G05B 19/406; G05B 2219/24015

(57) ABSTRACT

The present disclosure provides a method, an Internet of things (IoT) system, and a medium for safety monitoring of a particulate matter in a smart gas pipeline network. The method includes: obtaining concentration data of a pipeline area; generating a concentration level for the pipeline area based on the concentration data and generating a concentration level marker in a preset display machinery; determining a concentration level difference based on the concentration level for the pipeline area; determining a pipeline to be inspected based on the concentration level difference and generating a marker of the pipeline to be inspected in the preset display machinery; generating a pipeline inspection instruction based on the pipeline to be inspected; generating a pipeline inspection work order; and regulating, based on an execution result of the pipeline inspection work order and/or the concentration level difference, an operating parameter of pipeline ancillary equipment in the pipeline area.

### CROSS-REFERENCE TO RELATED APPLICATIONS

This application claims the priority to Chinese Patent Application No. 202510998397.6, filed on Jul. 21, 2025, the contents of which are hereby incorporated by reference.

### TECHNICAL FIELD

The present disclosure relates to the field of particulate matter monitoring, and in particular, to methods, Internet of Things (IoT) systems, and mediums for safety monitoring of particulate matter in a smart gas pipeline network.

### BACKGROUND

Gas transmission is usually accompanied by particle flow. Usually, a high concentration of particulate matter indicates potential faults in gas pipelines, increases gas transmission resistance, accelerates pipe wall erosion, and corrodes pipelines and equipment. To prevent gas pipeline failures, monitoring the particulate matter content in a gas pipeline network is a problem that needs to be solved.

Therefore, methods, Internet of things (IoT) systems, and mediums for safety monitoring of a particulate matter in a smart gas pipeline network are provided to improve the efficiency of monitoring the concentration of the particulate matter and the operation and maintenance of the gas pipeline network by visualizing and displaying the concentration level of the particulate matter in the pipeline, and ensure the efficiency of gas pipeline network transportation by timely adjusting the related equipment.

### SUMMARY

One or more embodiments of the present disclosure provide a method for safety monitoring of a particulate matter in a smart gas pipeline network, wherein the method is executed by a gas company management platform of an Internet of things (IoT) system for safety monitoring of the particulate matter in the smart gas pipeline network, the method comprises: obtaining, by a gas company sensing network platform, concentration data of the particulate matter in at least one pipeline area from a monitoring device of a gas equipment object platform; generating, based on the concentration data, a concentration level for the at least one pipeline area and generating a concentration level marker in a preset display machinery; determining a concentration level difference based on the concentration level for the at least one pipeline area; determining a pipeline to be inspected based on the concentration level difference and generating a marker of the pipeline to be inspected in the preset display machinery; generating a pipeline inspection instruction based on the pipeline to be inspected; generating a pipeline inspection work order based on the pipeline inspection instruction; and regulating, based on at least one of an execution result of the pipeline inspection work order and the concentration level difference, an operating parameter of pipeline ancillary equipment in the at least one pipeline area by the gas equipment object platform.

One or more embodiments of the present disclosure provide an Internet of things (IoT) system for safety monitoring of a particulate matter in a smart gas pipeline network, wherein the IoT system comprises a gas company management platform, a gas company sensing network platform, and a gas equipment object platform, the gas company management platform is configured to: obtain, by the gas company sensing network platform, concentration data of the particulate matter in at least one pipeline area from a monitoring device of the gas equipment object platform; generate, based on the concentration data, a concentration level for the at least one pipeline area and generate a concentration level marker in a preset display machinery; determine a concentration level difference based on the concentration level for the at least one pipeline area; determine a pipeline to be inspected based on the concentration level difference and generate a marker of the pipeline to be inspected in the preset display machinery; generate a pipeline inspection instruction based on the pipeline to be inspected; generate a pipeline inspection work order based on the pipeline inspection instruction; and regulate, based on at least one of an execution result of the pipeline inspection work order and the concentration level difference, an operating parameter of pipeline ancillary equipment in the at least one pipeline area by the gas equipment object platform.

One or more embodiments of the present disclosure provide a non-transitory computer-readable storage medium storing computer instructions. When reading the computer instructions in the storage medium, a computer implements the method described in the abovementioned embodiments.

### BRIEF DESCRIPTION OF THE DRAWINGS

This present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram of a platform structure of an Internet of Things (IoT) system for safety monitoring of particulate matter in a smart gas pipeline network according to some embodiments of the present disclosure;

FIG. 2 is an exemplary flowchart of a method for safety monitoring of a particulate matter in a smart gas pipeline network according to some embodiments of the present disclosure;

FIG. 3 is an exemplary flowchart for determining a pipeline to be inspected according to some embodiments of the present disclosure; and

FIG. 4 is an exemplary schematic diagram of a particulate matter model according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. The accompanying drawings do not represent the entirety of the embodiments.

When describing the operations performed in the embodiments of the present disclosure in step-by-step instructions, the order of the steps is all interchangeable if not otherwise specified, the steps are optional, and other steps may be included in the operation.

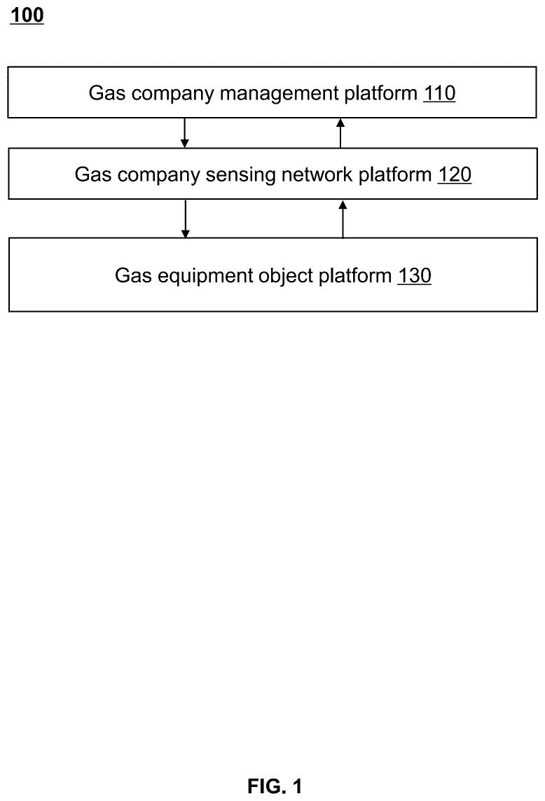

FIG. 1 is a schematic diagram of a platform structure of an Internet of Things (IoT) system for safety monitoring of particulate matter in a smart gas pipeline network according to some embodiments of the present disclosure.

In some embodiments, as shown in FIG. 1, the Internet of Things (IoT) system 100 for safety monitoring of a particulate matter in a smart gas pipeline network may include a gas company management platform 110, a gas company sensing network platform 120, and a gas equipment object platform 130.

The gas company management platform refers to a comprehensive management platform for gas company information. In some embodiments, the gas company management platform is configured to process and store data from the Internet of Things (IoT) system 100 for safety monitoring of a particulate matter in a smart gas pipeline network. The gas company management platform includes a processor, a storage device, or the like. The processor includes central processing units (CPUs), application specific integrated circuits (ASICs), application specific instruction processors (ASIPs), graphics processors (GPUs), etc., or any combination thereof.

The gas company sensing network platform refers to a platform that comprehensively manages the sensing information of the gas company. In some embodiments, the gas company sensing network platform is configured as a communication network or gateway, etc. The gas company sensing network platform interacts with the gas company management platform and a gas equipment object platform.

The gas equipment object platform refers to a functional platform for sensing information generation and controlling information execution. In some embodiments, the gas equipment object platform includes a monitoring device, pipeline ancillary equipment, etc. The pipeline ancillary equipment includes at least one of a filter, a pressure regulator cabinet, a flow rate regulating valve, etc.

The monitoring device refers to a device (e.g., a particulate matter monitor, etc.) for monitoring the concentration of a particulate matter mixed in the gas.

The filter is configured to filter the particulate matter from the gas. The pressure regulator cabinet is configured to control a gas pressure in the gas pipeline. The flow rate regulating valve is configured to control a gas flow rate in the gas pipeline.

In some embodiments, the filter includes two channels, one channel is a filtering channel that includes a filter cartridge, and the other channel is an unobstructed channel that does not include a filter cartridge. Filter activation refers to opening the filtering channel and closing the unobstructed channel. Filter closure refers to closing the filtering channel and opening the unobstructed channel. The opening and closing status of the filter may be indicated by a numerical value, etc., for example, 0 indicates the filter is turned off and 1 indicates the filter is activated.

In some embodiments, the pipeline ancillary equipment, such as the monitoring device, the filter, the pressure regulator cabinet, the flow rate regulating valve, etc., is deployed at a preset equipment location in the gas pipeline network. The preset equipment location is preset by a person of the gas company, e.g., a common starting time point of a plurality of downstream pipelines, an outlet of a gas gate station, and/or pressure regulating station, etc. The gas pipeline network refers to a network of pipelines that transport gas.

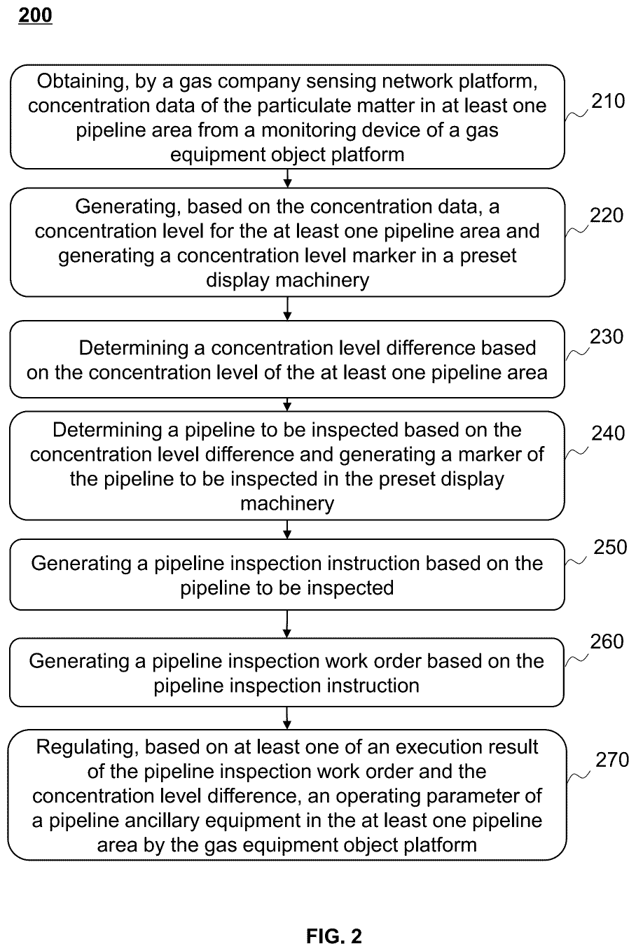

More descriptions regarding the foregoing may be found in FIG. 2 to FIG. 4 and the relevant descriptions.

In some embodiments of the present disclosure, based on the Internet of things (IoT) system 100 for safety monitoring of a particulate matter in a smart gas pipeline network, an information operation loop can be formed between various functional platforms, coordinate and operate regularly, and achieve the informatization and intelligence of the particulate matter in the smart gas pipeline network.

FIG. 2 is an exemplary flowchart of a method for safety monitoring of a particulate matter in a smart gas pipeline network according to some embodiments of the present disclosure. In some embodiments, the process 200 may be executed by a gas company management platform (hereinafter referred to as a company management platform) in the Internet of Things (IoT) system for safety monitoring of a particulate matter in a smart gas pipeline network. As shown in FIG. 2, the process 200 includes the following operations.

In 210, concentration data of the particulate matter in at least one pipeline area is obtained by a gas company sensing network platform from a monitoring device of a gas equipment object platform.

More descriptions regarding the platforms of the Internet of Things (IoT) system for safety monitoring of a particulate matter in a smart gas pipeline network and the monitoring device may be found in FIG. 1 and relevant descriptions.

The pipeline area refers to an area in a gas pipeline network that contains at least one pipeline. In some embodiments, the company management platform divides one or more pipelines between two monitoring devices into a pipeline area.

In some embodiments, the company management platform pre-numbers all of the pipelines in the gas pipeline network and represents different pipeline areas by sets of numbers of the pipelines in the different pipeline areas.

The concentration data refers to data related to the concentration of the particulate matter in the gas. The concentration data is expressed by numerical values, and the concentration data is expressed in milligrams per cubic meter. The particulate matter refers to a particulate matter mixed in the gas. The particulate matter includes at least one of rock particles, ferrous sulfide, or the like.

In some embodiments, the company management platform obtains the concentration data from the monitoring devices of the gas equipment object platform via the gas company sensing network platform. The monitoring device acquires the concentration data based on an acquisition parameter, etc., and uploads it to the gas company sensing network platform. More descriptions regarding the acquisition parameter may be found in operation 270 and the relevant descriptions.

In some embodiments, the concentration of the particulate matter in a pipeline area is represented by an average, etc., of the concentration data collected by the monitoring devices at both ends of the pipeline area.

In 220, a concentration level for the at least one pipeline area is generated based on the concentration data, and a concentration level marker is generated in a preset display machinery.

The concentration level refers to a level that characterizes the magnitude of the concentration data. For example, the higher the concentration level, the larger the concentration data, and the higher the concentration of the particulate matter in the corresponding pipeline area.

In some embodiments, the company management platform generates, based on the concentration data, the concentration level for at least one pipeline area. For example, the company management platform queries, based on the concentration data of the pipeline area, a reference concentration interval in a preset level table that contains the concentration data, and determines a reference concentration level corresponding to the reference concentration interval as the concentration level for the pipeline area.

The preset level table is preset based on historical data and includes a preset level number of reference concentration intervals and the reference concentration level corresponding to each reference concentration interval.

In some embodiments, the company management platform acquires a plurality of historical concentration data in the historical data, averages an interval between 0 and the maximum among the plurality of historical concentration data into a plurality of concentration intervals, calculates an occurrence ratio for each concentration interval, and merges, based on a merging rule, the plurality of concentration intervals to obtain the preset level number of reference concentration intervals. The count of the plurality of concentration intervals and the preset level number are preset based on historical experience. The occurrence ratio of a concentration interval refers to a ratio of the count of occurrences of the plurality of historical concentration data in the concentration interval to a total count of historical concentration data.

The merging rule refers to a rule used to merge concentration intervals. In some embodiments, the merging rule includes merging concentration intervals with the same count of occurrence ratio into a single reference concentration interval based on the occurrence ratios, in the order of concentration intervals from smallest to largest. Exemplarily, there are a total of 50 concentration intervals, and the company management platform screens the concentration intervals in order from smallest to largest. If a concentration interval with an occurrence ratio of less than 0.05 is a concentration interval that is ordered from 0 to 30, the company management platform divides the concentration intervals ordered from 0 to 30 into a reference concentration interval corresponding to a reference concentration level 0. If the concentration interval with an occurrence ratio of less than 0.1 and greater than 0.05 is a concentration interval that is ordered from 31 to 35, the company management platform divides the concentration intervals ordered from 31 to 35 into a reference concentration interval corresponding to a reference concentration level 1. And so on, the preset level number of reference concentration intervals and the corresponding reference concentration level may be got. The occurrence ratios (e.g., 0.05, etc.) to divide the plurality of concentration intervals into a single reference interval is preset by the user based on historical experience.

In some embodiments, the preset level number is determined by a manner such as manual labeling or evaluation by the company management platform. For example, the Internet of things (IoT) system for safety monitoring of a particulate matter in a smart gas pipeline network randomly generates different level numbers, conducts trial runs based on the different level numbers, evaluates the effect of each trial run by a manual annotation or the company management platform, and determines the level number corresponding to the best trial run effect as the preset level number. The best trial run effect includes at least one of the lowest failure rate of the gas pipeline network during the trial run, the highest rate of hidden trouble detection of the gas pipeline network, and the lowest hardware operating load of the gas pipeline network.

The preset display machinery refers to a system that has functions such as displaying the gas pipeline network, making the gas pipeline network, or the like. In some embodiments, the preset display machinery includes a gas geographic information system (GIS system), etc. The preset display machinery is configured to display the gas pipeline network, gas gate stations, pressure regulating stations, etc., in the gas pipeline network, and mark and display the pipelines, or the like. The marking in the preset display machinery may include at least one of a numerical marking, a color marking, a highlighting marking, etc.

The concentration level marker refers to a marker that represents the concentration level for the pipeline area. In some embodiments, in response to the company management platform determining the concentration level for at least one pipeline area, the preset display machinery displays the concentration level marker on the corresponding pipeline area in the displayed gas pipeline network.

In 230, a concentration level difference is determined based on the concentration level for the at least one pipeline area.

The concentration level difference is used to characterize a difference of concentration levels between adjacent pipeline areas. The adjacent pipeline areas include an upstream pipeline area and a downstream pipeline area.

In some embodiments, the concentration level difference of the adjacent pipeline areas is represented by a concentration level difference between the downstream pipeline area and the upstream pipeline area. For each set of adjacent pipeline areas, the company management platform calculates a difference between the concentration level for the downstream pipeline area and the concentration level for the upstream pipeline area, and recognizes the difference as the concentration level difference for that adjacent pipeline area.

In some embodiments, if the downstream pipeline area corresponds to a plurality of upstream pipeline areas, the company management platform calculates differences between the concentration level for the downstream pipeline area and the concentration level for each of the plurality of upstream pipeline areas, respectively, and recognizes the maximum of the differences as the concentration level difference of the adjacent pipeline areas.

In 240, a pipeline to be inspected is determined based on the concentration level difference, and a marker of the pipeline to be inspected is generated in the preset display machinery.

The pipeline to be inspected refers to a pipeline that needs to be inspected.

In some embodiments, the company management platform identifies the pipeline to be inspected in a plurality of ways. For example, the company management platform filters adjacent pipeline areas with a concentration level difference that is not less than a first difference threshold and identifies pipelines in the downstream pipeline area of the adjacent pipeline areas as the pipeline to be inspected. The first difference threshold is preset based on historical experience.

In some embodiments, the company management platform adjusts the first difference threshold based on an execution result of a pipeline inspection work order. For example, the company management platform counts a count of negative results in the execution results, calculates a ratio of the count of negative results to the total count of the execution results, and adjusts upwardly the first difference threshold if the obtained ratio is less than an adjustment threshold. The adjustment threshold is preset based on historical experience. More descriptions regarding the execution result of the pipeline inspection work order may be found in operation 270 and the relevant descriptions.

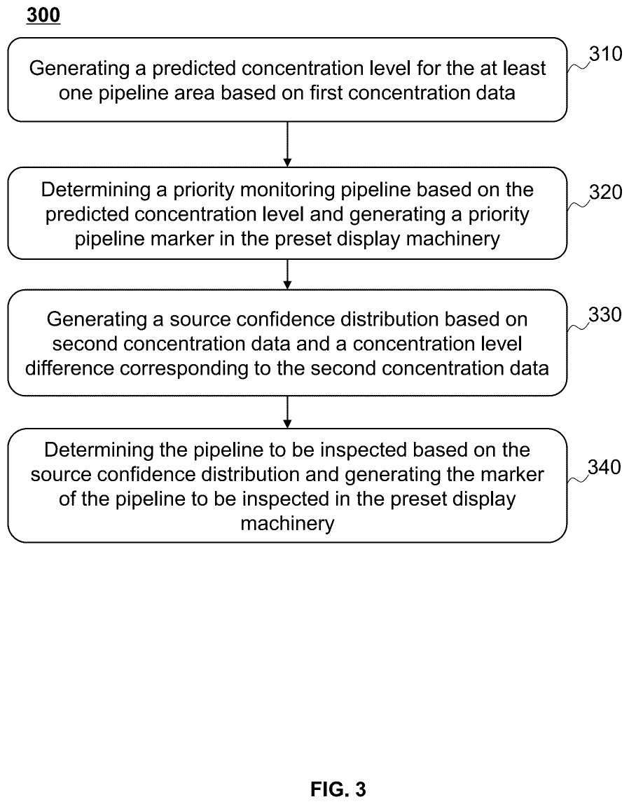

In some embodiments, the company management platform determines the pipeline to be inspected based on a source confidence distribution, as described in FIG. 3 and its related descriptions.

The marker of the pipeline to be inspected refers to a marker that indicates the pipeline to be inspected.

In some embodiments, in response to the company management platform identifying the pipeline to be inspected, the preset display machinery displays the marker of the pipeline to be inspected on the corresponding pipeline to be inspected in the displayed gas pipeline network.

In 250, a pipeline inspection instruction is generated based on the pipeline to be inspected.

The pipeline inspection instruction refers to a control instruction that directs the generation of the pipeline inspection work order.

In some embodiments, the company management platform generates the pipeline inspection instruction based on the pipeline to be inspected. For example, the company management platform generates the pipeline inspection instruction based on the number and the concentration level difference of the pipeline to be inspected.

In 260, a pipeline inspection work order is generated based on the pipeline inspection instruction.

The pipeline inspection work order refers to a work order for assigning pipeline inspection tasks. In some embodiments, the pipeline inspection work order includes the number of the pipeline to be inspected, a pipeline inspection task to be performed, etc. The pipeline inspection task includes at least one of checking the thickness of a pipeline attachment, checking the pipeline for deterioration, maintaining the filter, or the like.

In some embodiments, the company management platform generates the pipeline inspection work order based on the pipeline inspection instruction. For example, based on the pipeline inspection instruction, the company management platform queries a pipeline inspection task corresponding to the concentration level difference in a task comparison table and generates the pipeline inspection work order based on the number of the pipeline to be inspected and the identified pipeline inspection task. The task comparison table is preset based on historical experience and includes a plurality of concentration level differences and a pipeline inspection task corresponding to each concentration level difference.

In some embodiments, the company management platform sends the pipeline inspection work order to a terminal device of the pipeline network maintenance personnel through wireless transmission, etc.

In 270, an operating parameter of pipeline ancillary equipment in the at least one pipeline area is regulated based on at least one of an execution result of the pipeline inspection work order and the concentration level difference by the gas equipment object platform.

More descriptions regarding the pipeline ancillary equipment may be found in FIG. 1 and the relevant descriptions.

The execution result of the pipeline inspection work order refers to a result of the inspection of the pipeline by the pipeline network maintenance personnel based on the pipeline inspection work order. The execution result includes a negative result and a positive result. The negative result includes the need for pipeline cleaning, etc. The positive result includes that the pipeline is not abnormal, etc.

In some embodiments, the pipeline network maintenance personnel upload the execution result to the company management platform via the terminal device.

The operating parameter refers to a parameter related to the work of the pipeline ancillary equipment. For example, the operating parameter includes at least one of whether or not a filter is turned on, a gas pressure regulated by a regulator cabinet, a gas flow rate limited by a flow rate regulating valve, or the like.

In some embodiments, the company management platform regulates, based on the execution result of the pipeline inspection work order and/or the concentration level difference, the operating parameter of the pipeline ancillary equipment in the at least one pipeline area via the gas equipment object platform. For example, when the execution result of the inspection is a negative result, the company management platform controls, via the gas equipment object platform, the opening of a filter in the upstream pipeline area of the pipeline to be inspected, and controls the opening of the filter when the cleaning of the pipeline is completed. As another example, in response to the concentration level difference being greater than a second difference threshold, the company management platform turns on the filters in the upstream pipeline area of the pipeline to be inspected in advance. The second difference threshold is preset based on historical experience.

In some embodiments, the company management platform obtains a marker of the at least one pipeline area through the preset display machinery, and sets the acquisition parameter of the monitoring device based on the marker.

In some embodiments, the company management platform obtains, via the preset display machinery, the marker of the at least one pipeline area. The marker includes at least one of a concentration level marker, a marker of the pipeline to be inspected, and a priority pipeline marker. More descriptions regarding the priority pipeline marker may be found in FIG. 3 and relevant descriptions.

In some embodiments, the company management platform determines a monitoring priority of the at least one pipeline area based on the marker. The monitoring priority is used to characterize a priority degree for obtaining the concentration data.

In some embodiments, different pipeline areas with different markers correspond to different monitoring priorities. For example, the monitoring priority of the pipeline area corresponding to the marker of the pipeline to be inspected is greater than the monitoring priority of the pipeline area corresponding to the priority pipeline marker, and the monitoring priority of the pipeline area corresponding to the priority pipeline marker is greater than the monitoring priority of the other pipelines. The other pipelines refer to pipelines in the pipeline network other than the pipeline to be inspected and a priority monitoring pipeline.

In some embodiments of the present disclosure, by dividing the monitoring priorities of different pipeline areas, it is possible to identify pipeline areas that are more in need of prioritizing the acquisition of the concentration data, thereby achieving more targeted particulate matter monitoring.

The acquisition parameter of the monitoring device refers to a parameter used to instruct the monitoring device to perform data acquisition work. In some embodiments, the acquisition parameter includes an acquisition period, an acquisition time, etc. The acquisition period refers to a time interval between each data acquisition by the monitoring device. The acquisition time refers to the time taken by the monitoring device to acquire data each time.

In some embodiments, the company management platform sets the acquisition parameter of the monitoring device in a plurality of ways. For example, the company management platform counts the concentration data of each pipeline area, sorts the concentration data according to the magnitude of the concentration data, and determines the acquisition parameter of the monitoring device corresponding to the pipeline area based on the sorting result. The higher the sorting result of the concentration data corresponding to the monitoring device, the shorter the acquisition period, the longer the acquisition time.

In some embodiments, the company management platform sets the acquisition parameter of the monitoring device based on the marker. For example, the company management platform, based on the monitoring priorities of the pipeline areas determined by the markers, sorts the plurality of pipeline areas corresponding to each monitoring priority according to the magnitude of the concentration data. The company management platform sequentially determines, based on the maximum amount of data processing and the minimum amount of data confirmation, the acquisition parameters of the monitoring devices corresponding to the pipeline areas according to the sorting result of the monitoring priorities and the sorting result of the plurality of pipeline areas corresponding to each monitoring priority, until the company management platform reaches the maximum amount of data processing.

The maximum amount of data processing refers to a maximum amount of data that may be processed by the company management platform per unit of time without interfering with gas operation. The unit of time includes 1 second, etc. The minimum amount of data confirmation refers to a minimum amount of data required to determine the acquisition parameter for the monitoring device.

The minimum amount of data confirmation is determined based on historical data. For example, the company management platform screens historical similar data (e.g., a pipeline area similar to the current pipeline area and a particulate matter concentration, a gas flow rate, and a gas pressure in the similar pipeline area) from the historical data. If a ratio of the count of historical similar data in which the source of the particulate matter in the historical similar data is consistent with the actual test result to a total count of historical similar data is greater than a ratio threshold, an average amount of data required to determine the acquisition parameter in this batch of historical similar cases is determined as the minimum amount of data confirmation. The ratio threshold is preset based on historical experience.

In some embodiments, the company management platform constructs a region feature vector based on a region feature of the current pipeline area, constructs historical feature vectors based on historical region features of historical pipeline areas in the historical data, matches the region feature vector with the historical feature vectors, selects the historical feature vectors that satisfy a matching condition, and takes the pipeline areas corresponding to such historical feature vectors and the data such as the particulate matter concentration, the gas flow rate, and the gas pressure of the pipeline areas as historical similar data. The region feature includes the size of the pipeline area, the count of included pipelines, or the like. The region feature is obtained by the preset display machinery.

In some embodiments of the present disclosure, by distinguishing the monitoring priorities of different pipeline areas, it is possible to target some of the pipeline areas that are prone to hidden dangers due to the particulate matter concentration for focusing on and dealing with them, thereby improving the efficiency of the operation and maintenance of the gas pipeline network.

In some embodiments of the present disclosure, the pipeline to be inspected can be quickly identified by the concentration level difference of adjacent pipeline areas, and by visualizing the concentration level of particulate matter in the pipeline, the efficiency of the particulate matter concentration monitoring can be improved. At the same time, based on the pipeline to be inspected, the pipeline inspection work order is generated in a targeted manner, and then the pipeline to be inspected is inspected promptly, so that a rapid response can be made when the concentration data in the gas pipeline is abnormal, to ensure that the gas pipeline network is delivered efficiently.

FIG. 3 is an exemplary flowchart for determining a pipeline to be inspected according to some embodiments of the present disclosure. In some embodiments, a process 300 may be performed by a company management platform. As shown in FIG. 3, the process 300 includes the following operations.

In some embodiments, the company management platform generates a predicted concentration level for the at least one pipeline area based on first concentration data; determines a priority monitoring pipeline based on the predicted concentration level; generates a source confidence distribution based on second concentration data and a concentration level difference corresponding to the second concentration data; and determines a pipeline to be inspected based on the source confidence distribution.

In 310, a predicted concentration level for at least one pipeline area is generated based on first concentration data.

The first concentration data refers to one piece of concentration data at a first time point. In some embodiments, the first concentration data includes concentration data of a particulate matter in the at least one pipeline area at the first time point.

The first time point refers to a time point before the current time point when a monitoring device last acquired the concentration data. The first time point corresponding to each pipeline area is the same or different.

In some embodiments, the company management platform obtains the first concentration data from historical concentration data. The historical concentration data refers to one piece of concentration data in the historical data. The company management platform obtains the historical concentration data from a storage device, and takes the concentration data of the at least one pipeline area at the first time point in the historical concentration data as the first concentration data.

The predicted concentration level refers to a predicted concentration level for the pipeline area. More descriptions regarding the concentration level may be found in operation 220 and the relevant descriptions.

In some embodiments, the company management platform determines the predicted concentration level in a plurality of ways. For example, for each pipeline area, the company management platform calculates a product of the first concentration data of the pipeline area and a pollution value ratio, determines the resulting product as a predicted concentration of the pipeline area, and determines the concentration level corresponding to the predicted concentration as the predicted concentration level by querying the preset level table to determine the concentration level based on the concentration data in operation 220.

The pollution value ratio refers to a ratio of a gas pollution value of the gas transported in the pipeline area at the current time point to a gas pollution value at the first time point.

The gas pollution value refers to one piece of data related to a degree to which the gas is polluted. In some embodiments, the gas pollution value correlates to the concentration data of an outgoing gas, such as the gas pollution value is positively correlated to the concentration data of the outgoing gas. Exemplarily, the company management platform calculates the gas pollution value using the following formula (1):

$${R}_{w} = 1 + \frac{N}{1000} , \qquad ( 1 )$$

where, R_{w} denotes the gas pollution value, and N denotes the concentration data of the outgoing gas. The outgoing gas refers to a gas at an outlet of a gas gate station or a pressure regulating station in the upstream of the pipeline area. The concentration data of the outgoing gas is obtained by the monitoring device disposed at the outlet of the gas gate station or pressure regulating station.

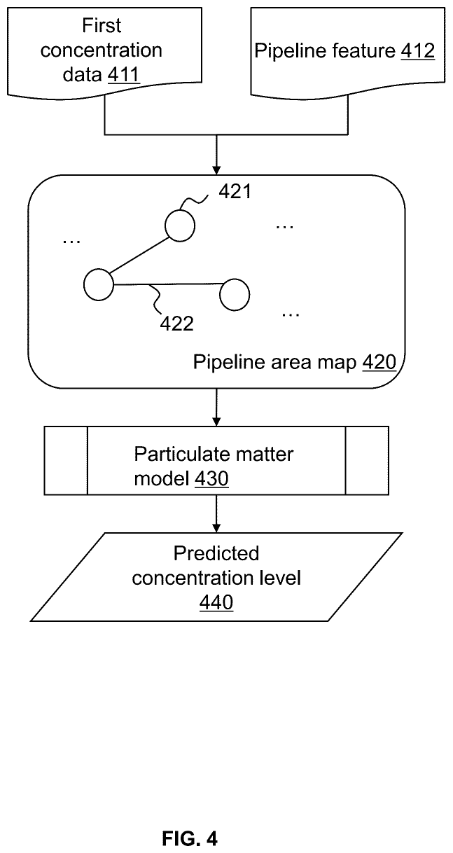

In some embodiments, the company management platform generates the predicted concentration level for the at least one pipeline area via a particulate matter model, for which see FIG. 4 and its related description.

In some embodiments, the first concentration data further includes concentration sequence data of the particulate matter in the at least one pipeline area at a plurality of third time points. The company management platform generates a concentration change magnitude of the at least one pipeline area at the plurality of third time points based on the concentration sequence data, and generates the predicted concentration level for the at least one pipeline area based on the concentration change magnitude.

The third time point refers to one time point of a plurality of historical time points before the current time point. In some embodiments, the plurality of third time points and a count of third time points are preset based on historical experience, and the last of the plurality of third time points refers to the first time point. The third time points of different pipeline areas are the same or different.

In some embodiments, the company management platform determines a starting time point of the plurality of third time points based on a plurality of ways. The starting time point refers to a first time point with the earliest time among the plurality of third time points. For example, if a filter exists in an upstream pipeline area within a preset adjacency degree of the current pipeline area, the time point at which the filter was last adjusted to open and close is used as the starting time point. The adjacency degree is used to characterize the count of pipeline areas or pipelines separated by two pipeline areas or pipelines. The preset adjacency degree is preset based on historical experience.

As another example, if a filter does not exist in the upstream pipeline area within the preset adjacency degree of the current pipeline area, a concentration breakpoint within a historical time is used as the starting time point, or the starting time point is preset by the user. The concentration breakpoint refers to a time point when a direction of the magnitude of the concentration data changes (e.g., rises or falls).

The concentration sequence data refers to a sequence of concentration data corresponding to the plurality of third time points. In some embodiments, the concentration data in the concentration sequence data may be arranged in chronological order.

The concentration change magnitude refers to a change magnitude of the concentration data in the concentration sequence data. In some embodiments, the concentration change magnitude includes multiple pieces of data, each of which corresponds to a change magnitude in the concentration data between a third time point and the previous third time point or a reference time point. The reference time point may be a third time point that is ranked in the first place (earliest) in the concentration sequence data.

In some embodiments, the company management platform calculates the change magnitude of the concentration data between a third time point and the previous third time point or the reference time point based on the concentration sequence data. The change magnitude is represented by a ratio between the third time point and the previous third time point or reference time point.

In some embodiments, the company management platform determines a predicted concentration based on the concentration change magnitude, and generates the predicted concentration level for the at least one pipeline area based on the predicted concentration. Exemplarily, the company management platform determines the predicted concentration based on the concentration change magnitude by using the following formula (2):

$${Y}_{g} = {N}_{1} \times ( 1 + {B}_{p} ) , \qquad ( 2 )$$

where Y_{g} is the predicted concentration, N₁ is the first concentration data, and Bₚ is an average of the multiple pieces of data in the concentration change magnitude.

In some embodiments, the company management platform determines the predicted concentration level based on the predicted concentration by the manner of determining the concentration level in operation 220.

In some embodiments of the present disclosure, by determining the predicted concentration level based on the change magnitude of the concentration data at the plurality of third time points, the change in the concentration data can be taken into account, thereby improving the accuracy of determining the predicted concentration level.

In some embodiments, the company management platform issues, via a gas equipment object platform, an adjustment instruction based on the concentration change magnitude to regulate an operating parameter. More descriptions of the operating parameter may be found in operation 260 and the relevant descriptions.

The adjustment instruction refers to a control instruction that adjusts the operating parameter. In some embodiments, the adjustment instruction includes changing a parameter of the flow rate regulating valve to adjust a gas flow rate.

In some embodiments, the adjusted gas flow rate correlates to the average of the multiple pieces of data in the concentration change magnitude, e.g., the adjusted gas flow rate negatively correlates to the average of the multiple pieces of data in the concentration change magnitude. Exemplarily, the company management platform determines the adjusted gas flow rate by the following formula (3):

$$S 1 = {S}_{q 1} \times ( 1 - {B}_{p} ) , \qquad ( 3 )$$

where, S1 is the gas flow rate in the pipeline area after adjustment, S_{q1} is the gas flow rate in the pipeline area before adjustment, and By is the average of the multiple pieces of data in the concentration change magnitude corresponding to the pipeline area.

In some embodiments, the adjusted gas flow rate may also be related to the source confidence distribution. More descriptions of the source confidence distribution may be found in operation 330 and the relevant descriptions.

In some embodiments, in response to the source of the particulate matter in the current pipeline area being from an associated upstream pipeline located the most upstream, the company management platform adjusts the gas flow rate of the associated upstream pipeline based on the source confidence distribution. Exemplarily, the company management platform determines the adjusted gas flow rate of the associated upstream pipeline following formula (4):

$$S 2 = {S}_{q 2} \times ( 1 - {B}_{p} \times Z ) , \qquad ( 4 )$$

where, S2 is the gas flow rate of the associated upstream pipeline after adjustment, S_{q2} is the gas flow rate of the associated upstream pipeline before adjustment, Bₚ is the average of the multiple pieces of data in the concentration change magnitude corresponding to the pipeline area, and Z is the confidence level of the source of the particulate matter. More descriptions of the most upstream associated upstream pipeline are provided in operation 330.

In some embodiments of the present disclosure, since the gas flow rate also affects the concentration data in the pipeline area, by adjusting the gas flow rate in the pipeline area based on changes in the concentration data determined in the concentration change magnitude, it can prevent more and more particulate matter from accumulating in the pipeline area. At the same time, combined with the source confidence distribution, targeted adjustment of the gas flow rate of the individual pipeline area can avoid adjusting the gas flow rate to affect the transmission stability of the entire gas pipeline network.

In 320, a priority monitoring pipeline is determined based on the predicted concentration level and a priority pipeline marker is generated in the preset display machinery.

The priority monitoring pipeline is a pipeline that requires focused monitoring.

In some embodiments, the company management platform determines the priority monitoring pipeline in a plurality of ways based on the predicted concentration level for the pipeline area. For example, the company management platform may identify a pipeline in the pipeline area with a predicted concentration level greater than a level threshold as the priority monitoring pipeline.

In some embodiments, the company management platform counts, in the historical data, historical concentration levels corresponding to the pipeline areas in which a negative result occurs in the execution result or in which the operating parameter of the pipeline ancillary equipment needs to be regulated, and recognizes the lowest value in the historical concentration levels as the level threshold.

In some embodiments, the company management platform calculates, based on the predicted concentration level for the pipeline area and the actual concentration level for the pipeline area at the first time point, a difference between the predicted concentration level and the actual concentration level, and identifies a pipeline in the pipeline area with a difference that is not less than a first difference threshold as a priority monitoring pipeline. The actual concentration level for the pipeline area at the first time point is obtained from historical data. More descriptions regarding the first difference threshold may be found in operation 240 and the relevant descriptions.

The priority pipeline marker refers to a marking that indicates a priority monitoring pipeline.

In some embodiments, in response to the company management platform identifying the priority monitoring pipeline, the preset display machinery displays the priority pipeline marker on the corresponding priority monitoring pipeline in the displayed gas pipeline network. More descriptions regarding the preset display machinery may be found in FIG. 2 and relevant descriptions.

In 330, a source confidence distribution is generated based on second concentration data and a concentration level difference corresponding to the second concentration data.

The second concentration data refers to one piece of concentration data at the second time point.

In some embodiments, the second concentration data includes concentration data of the particulate matter in the priority monitoring pipeline at a plurality of second time points.

The plurality of second time points refers to a plurality of future time points after the current time point. In some embodiments, the plurality of second time points of each pipeline area are the same or different. The plurality of second time points are preset based on historical experience.

In some embodiments, the second concentration data is obtained via the monitoring device corresponding to the priority monitoring pipeline. After the company management platform identifies the priority monitoring pipeline, each second time point is used as a time point for acquiring the concentration data.

The source confidence distribution refers to one piece of data used to characterize the source of the particulate matter in the gas in the at least one pipeline area and a confidence level of the source of the particulate matter. In some embodiments, the source confidence distribution is represented by a sequence, etc., and the sequence includes a pipeline area, the source of the particulate matter in the gas in the pipeline area, and a confidence level of the source of the particulate matter. The source of the particulate matter includes from the gas itself and/or the pipeline. The pipeline area in the sequence is indicated by numbering, etc. From the gas itself means that the particulate matter is self-contained as the gas is exported from the gas gate station, the pressure regulating station, or the like. From the pipeline means that the particulate matter is generated when the gas is transported from the upstream pipeline to the downstream pipeline.

In some embodiments, the company management platform generates the source confidence distribution based on the second concentration data and the concentration level difference corresponding to the second concentration data. For example, the company management platform determines an associated pipeline group of the priority monitoring pipeline based on the second concentration data and the concentration level difference corresponding to the second concentration data, determines a source of the particulate matter of the associated pipeline group, and determines the source confidence distribution based on the source of the particulate matter of the associated pipeline group.

The concentration level difference corresponding to the second concentration data refers to a difference between the concentration level for the priority monitoring pipeline and the concentration level for the upstream pipeline of the priority monitoring pipeline. The company management platform determines the concentration level for the priority monitoring pipeline based on an average or a median value, etc., of the second concentration data by the manner of determining the concentration level in operation 220. The company management platform determines the concentration level for the upstream pipeline based on the concentration data corresponding to the upstream pipeline by the manner of determining the concentration level in operation 220.

Associated pipeline group refers to a collection of a plurality of pipelines that have upstream and downstream associations. In some embodiments, the company management platform determines the associated pipeline group in a plurality of ways. For example, the priority monitoring pipeline is used as an associated pipeline group, and associated upstream pipelines of the priority monitoring pipeline are added to the associated pipeline group where the priority monitoring pipeline is located. The associated upstream pipeline refers to an upstream pipeline of which the concentration level difference corresponding to the second concentration data is not greater than the first difference threshold. More descriptions regarding the first difference threshold may be found in FIG. 2 and the relevant descriptions.

In some embodiments, if the associated upstream pipeline also has an upstream pipeline, and the concentration level difference between the associated upstream pipeline and its upstream pipeline is not greater than the first difference threshold, the company management platform also adds the upstream pipeline of the associated upstream pipeline as an associated upstream pipeline to the associated pipeline group. By analogy, the associated pipeline group is obtained that includes the priority monitoring pipeline and a plurality of associated upstream pipelines. If the concentration level difference between the associated upstream pipeline and its upstream pipeline is greater than the first difference threshold, the upstream pipeline of the associated upstream pipeline is no longer added as an associated upstream pipeline to the associated pipeline group, and the determination is stopped.

In some embodiments, if the most upstream associated upstream pipeline in the associated pipeline group also has an upstream pipeline, the company management platform determines the source of the particulate matter of the associated pipeline group as being from the most upstream associated upstream pipeline in the associated pipeline group and calculates the confidence level of the source of the particulate matter. The confidence level is used to characterize the reliability of the source of the particulate matter. The confidence level correlates with the concentration data of pipelines within the associated pipeline group. In some embodiments, the company management platform calculates the confidence level of the source of the particulate matter by the following formula (5):

$$Z = \frac{\vert {N}_{s} - {N}_{p} \vert}{{N}_{p}} , \qquad ( 5 )$$

where, Z is the confidence level, Nₛ is the concentration data of the most upstream associated upstream pipeline in the associated pipeline group, and Nₚ is an average of the concentration data of all pipelines in the associated pipeline group. The most upstream associated upstream pipeline refers to a first section of pipeline in the associated upstream pipelines of the associated pipeline group that is sorted according to the direction in which the gas is delivered.

In some embodiments, if the most upstream associated upstream pipeline in the associated pipeline group does not have an upstream pipeline, the company management platform determines that the source of the particulate matter of the associated pipeline group is from the gas itself.

In some embodiments, the source confidence distribution is also correlated to the gas flow rate of the priority monitoring pipeline.

In some embodiments, the company management platform calculates a plurality of correlation values for the priority monitoring pipeline, determines the priority monitoring pipeline as an associated pipeline group if the correlation values of the priority monitoring pipelines are all similar, and calculates a plurality of correlation values for the upstream pipeline of the priority monitoring pipeline. If the correlation values of the upstream pipelines are similar, the upstream pipelines are added to the associated pipeline group. And so on until the upstream pipeline does not satisfy that the correlation values are all similar or until there is no upstream pipeline, and the associated pipeline group is obtained.

The correlation value refers to a ratio of the concentration data of the pipeline at a single second time point to the gas flow rate at that second time point. The correlation values being similar means that a difference between any two correlation values of the plurality of correlation values is less than a correlation value threshold. The correlation value threshold is preset based on historical experience. The gas flow rate is obtained through a flow rate regulating valve. More descriptions regarding the flow rate regulating valve may be found in FIG. 1 and the relevant descriptions.

In some embodiments, if the upstream pipeline of the associated pipeline group does not satisfy the condition that the correlation values are all similar, the company management platform determines that the source of the particulate matter is from the upstream pipeline. If there is no upstream pipeline in the associated pipeline group, the company management platform determines that the source of the particulate matter is from the gas itself.

In some embodiments, the company management platform determines the confidence level that the source of the particulate matter is from the upstream pipeline based on a plurality of correlation values of the upstream pipelines and a plurality of correlation values of all the pipelines in the associated pipeline group. In some embodiments, the company management platform calculates the confidence level that the source of the particulate matter is from the upstream pipeline by the following formula (6):

$$W = \frac{\vert {G}_{s} - {G}_{p} \vert}{{G}_{p}} , \qquad ( 6 )$$

where, W is the confidence level that the source of the particulate matter is from the upstream pipeline, Gₛ is the average of the correlation values of the upstream pipeline, and Gₚ is the average of the correlation values of all pipelines in the associated pipeline group.

In some embodiments of the present disclosure, since the flow rate of the gas may affect the concentration data of the particulate matter, taking into account the flow rate of the gas when determining the source confidence distribution can improve the accuracy of the source confidence distribution, which in turn facilitates the subsequent accurate determination of the pipeline to be inspected.

In 340, the pipeline to be inspected is determined based on the source confidence distribution and the marker of the pipeline to be inspected is generated in the preset display machinery.

In some embodiments, the company management platform selects an associated pipeline group with a confidence level greater than a confidence threshold, identifies the most upstream associated upstream pipeline in the associated pipeline group as the pipeline to be inspected, and generates the marker of the pipeline to be inspected in the preset display machinery. The confidence threshold is preset based on historical experience. More descriptions regarding the preset display machinery and the marker of the pipeline to be inspected may be found in FIG. 1 and the relevant descriptions.

In some embodiments, if the confidence level that the source of the particulate matter is from the upstream pipeline determined by the correlation values is greater than the confidence threshold, the company management platform recognizes the upstream pipeline as the pipeline to be inspected.

It is understood that if the upstream of the pipeline is a first pipeline connected to a gas gate station or a pressure regulating station, etc., the particulate matter in the gas is produced by the gas gate station or the pressure regulating station, etc., and is handled by the regulator system of the gas gate station or the pressure regulating station.

In some embodiments of the present disclosure, by using the first concentration data to predict predicted concentration levels of different pipeline areas, it is possible to realize the pre-regulation of the gas pipeline network, reasonably determine the priority monitoring pipeline, improve the accuracy of determining the pipeline to be inspected, and then timely inspect the pipeline to be inspected, thereby pre-emptively preventing gas hazards. At the same time, by determining the source confidence distribution through the second concentration data, it is possible to take the priority monitoring pipeline with a higher confidence level as the pipeline to be inspected, reduce the amount of information processed by the company management platform, increase the efficiency of data processing, thereby improving the accuracy of determining the pipeline to be inspected.

It should be noted that the foregoing descriptions of process 200 and process 300 are for the purpose of exemplification and illustration only, and do not limit the scope of application of the present disclosure. For a person skilled in the art, various corrections and changes can be made to process 200 and process 300 under the guidance of this disclosure. However, these corrections and changes remain within the scope of this disclosure.

In some embodiments, the company management platform determines additional equipment locations based on the source confidence distribution, and regulates the operating parameter by the gas equipment object platform based on the source confidence distribution.

An additional equipment refers to a new pipeline ancillary equipment. The additional equipment includes a filter or a monitoring equipment, etc. The additional equipment location refers to a location where the new pipeline ancillary equipment is installed.

In some embodiments, the company management platform determines the additional equipment locations based on the source confidence distribution in a plurality of ways. For example, in response to the source of the particulate matter of the associated pipeline group being the most upstream associated upstream pipeline in the associated pipeline group and the source of the particulate matter having a confidence level greater than the confidence threshold, the company management platform confirms that the additional equipment location is an end location of the most upstream associated upstream pipeline. As another example, in response to the source of the particulate matter of the associated pipeline group being from the gas itself, the company management platform confirms that the additional equipment location is a starting point of the priority monitoring pipeline that does not have a filter installed.

An installation work order refers to a work order that is used to assign the installation of the additional equipment. In some embodiments, the installation work order includes the additional equipment locations, or the like. In some embodiments, the company management platform generates the installation work order based on the additional equipment locations and sends it to the pipeline network maintenance personnel to enable the pipeline network maintenance personnel to install the additional equipment.

In some embodiments, the company management platform dynamically regulates the operating parameter through the gas equipment object platform based on the source confidence distribution. For example, in response to the source of the particulate matter of the associated pipeline group being the most upstream associated upstream pipeline in the associated pipeline group and the source of the particulate matter having a confidence level greater than the confidence threshold, the company management platform, via the gas equipment object platform, controls the filters in all downstream pipeline areas corresponding to that associated upstream pipeline to be turned on, and the filters are turned off when the maintenance cleaning of that associated upstream pipeline is completed. Among all downstream pipeline areas corresponding to the associated upstream pipeline, only some of the downstream pipeline areas are equipped with filters.

As another example, in response to the source of the particulate matter in the associated pipeline group being from the gas itself, the company management platform inquiries, based on a pressure regulating demand, a pressure impact table to obtain a count of filters that need to be activated to meet the pressure regulating demand, and activates filters that meet the required count of filters that need to be activated among a plurality of filters corresponding to the associated pipeline group. The pressure regulating demand is preset based on historical data, for example, the pressure regulating demand is a gas pressure in the pipeline during the normal operation of the gas pipeline network. Because the activating of filters affects the gas pressure in the pipeline, the pressure regulating demand may be expressed in terms of the gas pressure. The plurality of filters corresponding to the associated pipeline group refer to filters in all downstream pipeline areas corresponding to the associated upstream pipeline.

In some embodiments, the company management platform prioritizes, among the plurality of filters corresponding to the associated pipeline group, activating the filters located in the upstream pipeline until the required count of filters that need to be activated is satisfied.

The pressure impact table is preset based on historical data, and includes a plurality of counts of filters that need to be activated and a drop in gas pressure in the pipeline corresponding to each count. The company management platform counts the count of filters that need to be activated of a single filter activation and the drop in gas pressure in the pipeline from the historical data as a single piece of data in the pressure impact table. The gas pressure is obtained through the regulator cabinet. More descriptions regarding the regulator cabinet may be found in FIG. 1 and the relevant descriptions.

In some embodiments of the present disclosure, when the existing filters cannot meet a filtering requirement, filters are added to the pipeline to improve the filtering effect. Considering that the filter filtration can affect the gas pressure, the number of filters to be turned on is dynamically regulated by the actual demand, which ensures the filtering effect while avoiding that the gas pressure is insufficient to affect the downstream gas use or increase the workload of the upstream pressure regulating station, so as to improve the stability of gas transmission.

In some embodiments, the company management platform regulates the operating parameter through the gas equipment object platform based on the predicted concentration level. For example, the company management platform regulates a working parameter of the filter via the gas equipment object platform based on the predicted concentration level. The working parameter includes an automatic cleaning cycle and a drain cycle for the filter, etc. The automatic cleaning cycle refers to a cycle in which the filter cleans automatically and produces impurities. The drain cycle refers to a cycle in which the filter automatically discharges the impurities generated by cleaning outside the filter.

In some embodiments, the company management platform counts predicted concentration levels of at least one upstream pipeline area of a single filter, determines a maximum value of the predicted concentration levels therein, and determines, by querying a filter parameter table, a reference working parameter that is the same as the maximum value as the working parameter of that filter.

The filter parameter table is preset based on historical experience and includes a plurality of concentration levels and corresponding reference working parameters. The company management platform counts historical working parameters of the filters corresponding to pipeline areas that satisfy the pressure regulating demand in the historical data, and records an average value of the historical working parameters and the concentration levels corresponding to the pipeline areas into the filter parameter table. The average value of the historical working parameters includes an average value of the historical automatic cleaning cycle and an average value of the historical drain cycle.

In some embodiments of the present disclosure, through the predicted concentration level, the working parameter of the filter can be regulated in advance, avoiding the situation where a large count of filters are overloaded at the same time, which leads to the centralized accumulation of the operation and maintenance tasks, improving the intelligence degree of delivery of the gas pipeline network, and reducing the impact of particulate matter in the gas on the quality of gas delivery.

FIG. 4 is an exemplary schematic diagram of a particulate matter model according to some embodiments of the present disclosure.

In some embodiments, the company management platform constructs a pipeline area map 420 based on a first concentration data 411 and a pipeline feature 412 of the at least one pipeline area; and generates, by a particulate matter model 430, a predicted concentration level 440 of the at least one pipeline area based on the pipeline area map 420.

More descriptions regarding the first concentration data and the predicted concentration level may be found in FIG. 4 and the relevant descriptions.

The pipeline area map refers to a map structure that is used to reflect a relative location of a monitoring device. The pipeline area map includes at least one node and at least one edge.

In some embodiments, the node of the pipeline area map includes a node representing the monitoring device (e.g., node 421). The feature of the node includes at least one of the first concentration data and the gas flow rate of the adjacent pipeline area upstream of the monitoring device, a filter installation condition, a turning on/off status, etc. The filter installation condition includes whether a filter is installed in the adjacent pipeline area upstream of the monitoring device. More descriptions regarding the monitoring device, the filter, and the obtaining of the gas flow rate may be found in FIG. 4 and relevant descriptions.

In some embodiments, the edge (e.g., edge 422) of the pipeline area map is used to represent a pipeline area between two nodes. The edge includes a directed edge, and the direction of the edge indicates a flow direction of gas. The feature of the edge includes a pipeline feature. The pipeline feature includes a pipeline distance between the pipeline area and the filter that is closest to the pipeline area in the upstream pipeline area of the pipeline area. The pipeline distance refers to a length of the pipeline. The company management platform obtains the pipeline distance through the preset display machinery.

In some embodiments, the company management platform constructs the node of the pipeline area map based on the location of the monitoring device, and determines the first concentration data and gas flow rate of the adjacent pipeline area upstream of the monitoring device, the filter installation condition, and the urning on/off status as features of the node. The company management platform determines the pipeline areas between the monitoring devices as edges between the nodes, and determines the pipeline features as the features of the edges to obtain the pipeline area map.

The particulate matter model refers to a model used to determine the predicted concentration level. In some embodiments, the particulate matter model is a machine learning model, such as, a graph neural network (GNN) model, etc., or any one or a combination of other customized model structures, etc.

In some embodiments, the input of the particulate matter model includes the pipeline area map. The output of the particulate matter model includes the predicted concentration level corresponding to each edge in the pipeline area map.

In some embodiments, the company management platform trains, such as by gradient descent, to obtain the particulate matter model based on a large number of labeled training samples. The first sample includes a sample pipeline area map, and the first label includes an actual concentration level corresponding to each edge in the sample pipeline area map.

In some embodiments, the company management platform constructs the sample pipeline area map based on historical data, and determines, in the historical data, a historical concentration level corresponding to each edge in the sample pipeline area map as the label.

In some embodiments, the particulate matter model may be obtained by training in the following manner: inputting a plurality of training samples with labels into an initial particulate matter model, constructing a loss function based on the labels and prediction results of the initial particulate matter model, and iteratively updates the initial particulate matter model based on the loss function. When the loss function of the initial particulate matter model meets a preset condition, the training of the particulate matter model is completed. The preset condition may be that the loss function converges, the count of iterations reaches a set value, or the like.

In some embodiments, the company management platform adjusts the training samples for subsequent use based on how the outputs of the initial particulate matter model differ from the label. For example, a difference value of each edge in the output results of the initial particulate matter model is counted, and a first-class edge and a second-class edge are selected. A first-class average value and a second-class average value are obtained by respectively calculating an average value of difference values of the first-class edges and second-class edges. The training samples used for subsequent use are adjusted based on the first-class average value and the second-class average value. The difference value of an edge refers to a difference between the edge output and the label corresponding to the edge. The first-class average value refers to an average value of the difference values of the first-class edges. The second-class average value refers to an average of the difference values of the second-class edges. The first-class edge refers to an edge within an adjacency degree where the upstream edge has a filter. The second-class edge refers to an edge within an adjacency degree where the upstream edge does not have a filter. More descriptions regarding the adjacency degree may be found in FIG. 3 and relevant descriptions.

Exemplarily, the company management platform calculates a sum of the first-class average value and the second-class average value. If a ratio of the first-class average value to the sum is greater than a preset adjustment threshold, the training samples for subsequent use are training samples containing more first-class edges, and if the ratio of the first-class average value to the sum is not greater than the preset adjustment threshold, the training samples for subsequent use are training samples containing more second-class edges. The preset adjustment threshold is preset based on historical experience.

It is understood that if the ratio of the first-class average value to the sum is greater than the preset adjustment threshold, it indicates that the output of the initial particulate matter model differs from the labels when dealing with the training samples that contains first-class edges, and subsequent training of the initial particulate matter model with training samples containing more first-class edges can obtain a more accurate particulate matter model. If the ratio of the first-class average value to the sum is not greater than the preset adjustment threshold, it indicates that the output of the initial particulate matter model differs from the labels when dealing with the training samples that contain second-class edges, and subsequent training of the initial particulate matter model with training samples containing more second-class edges can obtain a more accurate particulate matter model.

In some embodiments of the present disclosure, the particulate matter model is utilized to enable automated determination of the predicted concentration level and to improve the efficiency and accuracy of the determined predicted concentration level. Also, in determining the predicted concentration level, it is possible to take into account the effect of the pipeline distance between the pipeline area and the nearest filter on the concentration data, thereby improving the accuracy of the determined predicted concentration level.

Some embodiments of the present disclosure further provide a non-transitory computer-readable storage medium storing computer instructions, wherein when reading the computer instructions in the storage medium, a computer implements the method described in any of the above embodiments.

In addition, certain features, structures, or characteristics of one or more embodiments of the present disclosure may be suitably combined.

In some embodiments, the numerical parameters used in the specification and claims are approximations, and the approximations may be altered depending on the desired characteristics of individual embodiments. In some embodiments, the numerical parameters should take into account the specified number of valid digits and employ general place-keeping.

In the event of any inconsistency or conflict between the descriptions, definitions, and/or use of terminology in the materials cited in this specification and those set forth herein, the descriptions, definitions, and/or use of terminology herein shall prevail.

What is claimed is:

1. A method for safety monitoring of a particulate matter in a smart gas pipeline network, wherein the method is executed by a gas company management platform of an Internet of things (IoT) system for safety monitoring of a particulate matter in a smart gas pipeline network, and the method comprises:
obtaining, by a gas company sensing network platform, concentration data of a particulate matter in at least one pipeline area from a monitoring device of a gas equipment object platform;
generating, based on the concentration data, a concentration level for the at least one pipeline area and generating a concentration level marker in a preset display machinery;
determining a concentration level difference based on the concentration level for the at least one pipeline area;
determining a pipeline to be inspected based on the concentration level difference and generating a marker of the pipeline to be inspected in the preset display machinery;
generating a pipeline inspection instruction based on the pipeline to be inspected;
generating a pipeline inspection work order based on the pipeline inspection instruction; and
regulating, based on at least one of an execution result of the pipeline inspection work order and the concentration level difference, an operating parameter of pipeline ancillary equipment in the at least one pipeline area by the gas equipment object platform.

2. The method of claim 1, wherein the method further comprises:
generating a predicted concentration level for the at least one pipeline area based on first concentration data, the first concentration data including concentration data of the particulate matter in the at least one pipeline area at a first time point;
determining a priority monitoring pipeline based on the predicted concentration level and generating a priority pipeline marker in the preset display machinery;
generating a source confidence distribution based on second concentration data and a concentration level difference corresponding to the second concentration data, the second concentration data including concentration data of a particulate matter of the priority monitoring pipeline at a plurality of second time points, each of the plurality of second time points being later than the first time point; and
determining the pipeline to be inspected based on the source confidence distribution and generating the marker of the pipeline to be inspected in the preset display machinery.

3. The method of claim 2, wherein the generating a predicted concentration level for the at least one pipeline area based on first concentration data includes:
constructing a pipeline area map based on the first concentration data and a pipeline feature of the at least one pipeline area; and
generating, by a particulate matter model, the predicted concentration level for the at least one pipeline area based on the pipeline area map, the particulate matter model being a machine learning model.

4. The method of claim 2, wherein the method further comprises:
determining additional equipment locations based on the source confidence distribution;
generating an installation work order based on the additional equipment locations; and/or
regulating the operating parameter by the gas equipment object platform based on the source confidence distribution.

5. The method of claim 2, wherein the source confidence distribution correlates to a gas flow rate in the priority monitoring pipeline.

6. The method of claim 2, wherein the first concentration data further includes concentration sequence data of the particulate matter in the at least one pipeline area at a plurality of third time points, and the generating a predicted concentration level for the at least one pipeline area based on first concentration data includes:
generating a concentration change magnitude of the at least one pipeline area at the plurality of third time points based on the concentration sequence data; and
generating the predicted concentration level for the at least one pipeline area based on the concentration change magnitude.

7. The method of claim 6, wherein the method further comprises:
issuing, based on the concentration change magnitude, an adjustment instruction by the gas equipment object platform to regulate the operating parameter.

8. The method of claim 2, wherein the method further comprises:
regulating the operating parameter by the gas equipment object platform based on the predicted concentration level.

9. The method of claim 1, wherein the method further comprises:
obtaining a marker of the at least one pipeline area by the preset display machinery; and
setting acquisition parameters of the monitoring device based on the marker of the at least one pipeline area.

10. The method of claim 9, wherein the method further comprises:
determining a monitoring priority of the at least one pipeline area based on the marker of the at least one pipeline area.

11. An Internet of things (IoT) system for safety monitoring of a particulate matter in a smart gas pipeline network, wherein the IoT system comprises a gas company management platform, a gas company sensing network platform, and a gas equipment object platform, and the gas company management platform is configured to:
obtain, by the gas company sensing network platform, concentration data of a particulate matter in at least one pipeline area from a monitoring device of the gas equipment object platform;
generate, based on the concentration data, a concentration level for the at least one pipeline area and generate a concentration level marker in a preset display machinery;
determine a concentration level difference based on the concentration level for the at least one pipeline area;
determine a pipeline to be inspected based on the concentration level difference and generate a marker of the pipeline to be inspected in the preset display machinery;
generate a pipeline inspection instruction based on the pipeline to be inspected;
generate a pipeline inspection work order based on the pipeline inspection instruction; and
regulate, based on at least one of an execution result of the pipeline inspection work order and the concentration level difference, an operating parameter of pipeline ancillary equipment in the at least one pipeline area by the gas equipment object platform.

12. The system of claim 11, wherein the gas company management platform is further configured to:
generate a predicted concentration level for the at least one pipeline area based on first concentration data, the first concentration data including concentration data of the particulate matter in the at least one pipeline area at a first time point;
determine a priority monitoring pipeline based on the predicted concentration level and generate a priority pipeline marker in the preset display machinery;
generate a source confidence distribution based on second concentration data and a concentration level difference corresponding to the second concentration data, the second concentration data including concentration data of a particulate matter of the priority monitoring pipeline at a plurality of second time points, the plurality of second time points being later than the first time point; and
determine the pipeline to be inspected based on the source confidence distribution and generate the marker of the pipeline to be inspected in the preset display machinery.

13. The system of claim 12, wherein the gas company management platform is further configured to:
construct a pipeline area map based on the first concentration data and a pipeline feature of the at least one pipeline area; and
generate, by a particulate matter model, the predicted concentration level for the at least one pipeline area based on the pipeline area map, the particulate matter model being a machine learning model.

14. The system of claim 12, wherein the gas company management platform is further configured to:
determine additional equipment locations based on the source confidence distribution;
generate an installation work order based on the additional equipment locations; and/or
regulate the operating parameter by the gas equipment object platform based on the source confidence distribution.

15. The system of claim 12, wherein the first concentration data further includes concentration sequence data of the particulate matter in the at least one pipeline area at a plurality of third time points, and the gas company management platform further configured to:
generate a concentration change magnitude of the at least one pipeline area at the plurality of third time points based on the concentration sequence data; and
generate the predicted concentration level for the at least one pipeline area based on the concentration change magnitude.

16. The system of claim 15, wherein the gas company management platform is further configured to:
issue, based on the concentration change magnitude, an adjustment instruction by the gas equipment object platform to regulate the operating parameter.

17. The system of claim 12, wherein the gas company management platform is further configured to:
regulate the operating parameter, by the gas equipment object platform, based on a predicted concentration level.

18. The system of claim 11, wherein the gas company management platform is further configured to:
obtain a marker of the at least one pipeline area by the preset display machinery;
set acquisition parameters of the monitoring device based on the marker of the at least one pipeline area.

19. The system of claim 18, wherein the gas company management platform is further configured to:
determine a monitoring priority of the at least one pipeline area based on the marker of the at least one pipeline area.

20. A non-transitory computer-readable medium, storing computer instructions for safety monitoring of a particulate matter in a smart gas pipeline network, wherein when executed by at least one processor of a computing device, the computer instructions direct the at least one processor to perform operations including:
obtaining, by a gas company sensing network platform, concentration data of a particulate matter in at least one pipeline area from a monitoring device of a gas equipment object platform;
generating, based on the concentration data, a concentration level for the at least one pipeline area and generating a concentration level marker in a preset display machinery;
determining a concentration level difference based on the concentration level for the at least one pipeline area;
determining a pipeline to be inspected based on the concentration level difference and generating a marker of the pipeline to be inspected in the preset display machinery;
generating a pipeline inspection instruction based on the pipeline to be inspected;
generating a pipeline inspection work order based on the pipeline inspection instruction; and
regulating, based on at least one of an execution result of the pipeline inspection work order and the concentration level difference, an operating parameter of pipeline ancillary equipment in the at least one pipeline area by the gas equipment object platform.
